(19) United States
(12) Patent Application Publication
(10) Pub. No.: US 2008/0242498 A1
(43) Pub. Date: Oct. 2, 2008

(54) HYBRID VEHICLE INTEGRATED TRANSMISSION SYSTEM

(75) Inventors: Kenneth James Miller, Canton, MI (US); Scott Howard Gaboury, Ann Arbor, MI (US); Brandon R. Masterson, Dexter, MI (US); Walter Joseph Ortmann, Saline, MI (US); Marvin Paul Kraska, Dearborn, MI (US); Steven A. Daleiden, Milan, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/693,281

(22) Filed: Mar. 29, 2007

(51) Int. Cl. B60W 10/00

(52) U.S. Cl. 477/5; 475/5; 477/908

(57) ABSTRACT

A transmission for an alternatively powered vehicle includes an accessory unit selectively powered by at least one of an engine and a motor associated with the transmission. Clutches are used to selectively engage and disengage the engine and motor with the accessory unit.

### BACKGROUND OF THE INVENTION

1. Field of the Invention

The invention relates to hybrid vehicle integrated transmission systems.

2. Discussion

In some hybrid vehicles, supplemental units, e.g., air conditioning compressors, power steering pumps, water pumps, oil pumps, etc., may be driven by the engine. In other hybrid vehicles, supplemental units may be driven by dedicated electric motors.

### SUMMARY

Embodiments of the invention may take the form of a hybrid vehicle including first and second power sources and a transmission. The transmission includes an input shaft, a drive shaft, and a rotationally powered accessory device. The transmission is mechanically connected with the first power source via the input shaft and operatively connected with the second power source. The drive shaft is configured to be selectively driven by at least one of the first and second power sources. The accessory device is configured to selectively receive rotational power from the drive shaft.

Embodiments of the invention may take the form of a transmission system for a vehicle including first and second power sources and a wheel. The system transfers power from at least one of the power sources to the wheel. The system includes an input shaft mechanically connected with the first power source and a drive shaft. The system also includes a rotationally powered accessory device. The drive shaft is configured to be selectively driven by at least one of the first and second power sources. The accessory device is configured to selectively receive rotational power from the drive shaft.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a block diagram of an integrated transmission in accordance with an embodiment of the invention and shows the integrated transmission including an engine clutch, accessory clutch, and accessory unit.

FIG. 2 is another block diagram of an integrated transmission in accordance with an alternative embodiment of the invention and shows the integrated transmission including an engine clutch, accessory clutch, and accessory unit.

FIG. 3A is a schematic illustration of the engine clutch and accessory clutch of FIG. 1 and shows the engine clutch disengaged and the accessory clutch engaged.

FIG. 3B is another schematic illustration of the engine clutch and accessory clutch of FIG. 1 and shows the engine clutch engaged and the accessory clutch engaged.

FIG. 3C is yet another schematic illustration of the engine clutch and accessory clutch of FIG. 1 and shows the engine clutch engaged and the accessory clutch disengaged.

### DETAILED DESCRIPTION

Accessory units driven by a vehicle engine may not receive power when the engine is off. Dedicated electric motors for powering accessory units may add cost and weight to hybrid vehicle systems.

In some embodiments of the invention, a Hybrid Electric Vehicle (HEV) transmission is used to drive an air conditioning compressor thus eliminating any separate air conditioning motor. In other embodiments of the invention, a transmission is used to drive accessory pumps, e.g., water pump, oil pump, power steering pump, etc.

If the engine is shut down, for example, while a driver is stepping on a brake, the hybrid motor may be disconnected from the powertrain via a clutch. The motor may then drive the accessory unit, e.g., air conditioning compressor, while the engine is stopped. If the driver no longer steps on the brake, the engine may be re-connected to the motor via the clutch.

In some embodiments, a belt or shaft transfers the HEV motor torque to one or more accessory units internal to the transmission. Merging accessory units into the transmission may reduce cost and weight associated with such systems and provide packaging flexibility.

Depending on the type of hybrid transmission, e.g., power split, the clutch may (1) disconnect the vehicle wheels from the HEV motor, (2) disconnect the engine from the HEV motor, (3) or two clutches may disconnect the motor from both the engine and the transmission. For example, when the engine shuts-down, the hybrid motor may be disengaged from the engine via the clutch. The motor may then drive the accessory unit while the engine is stopped. If a driver tips in, the clutch may re-engage the motor with the engine, enabling the engine to pull-up.

In some embodiments, for a given operating condition, the power demand at each accessory unit is determined. The power requirements of each system are added together. The motor is commanded to provide the total power requirement. Then, the power is distributed to the individual accessory units.

Embodiments of the invention may (1) allow accessory devices to be operated during hybrid engine shutdown, without adding additional electric motors to drive the accessory devices; (2) allow efficient accessory device operation by using power directly from an engine, motor, or wheels (during breaking), or any combination thereof; (3) allow reduced cost and compact sizing of accessory devices, due to integrated design, e.g., i.) a fully integrated accessory device can share components/systems with a transmission unit, such as walls, shafts, oil, etc., ii.) a concentric drive is not belt driven so as to eliminates side bearing loads thus allowing less costly/smaller bearing/shaft design, etc., (4) allow greater efficiency due to concentric design which eliminates accessory drive belt losses and side loading; (5) allow increased under hood space where accessories devices are typically located; (6) allow efficient and cost effective routing of fluid lines; and/or (7) eliminate some or all accessory drive belts.

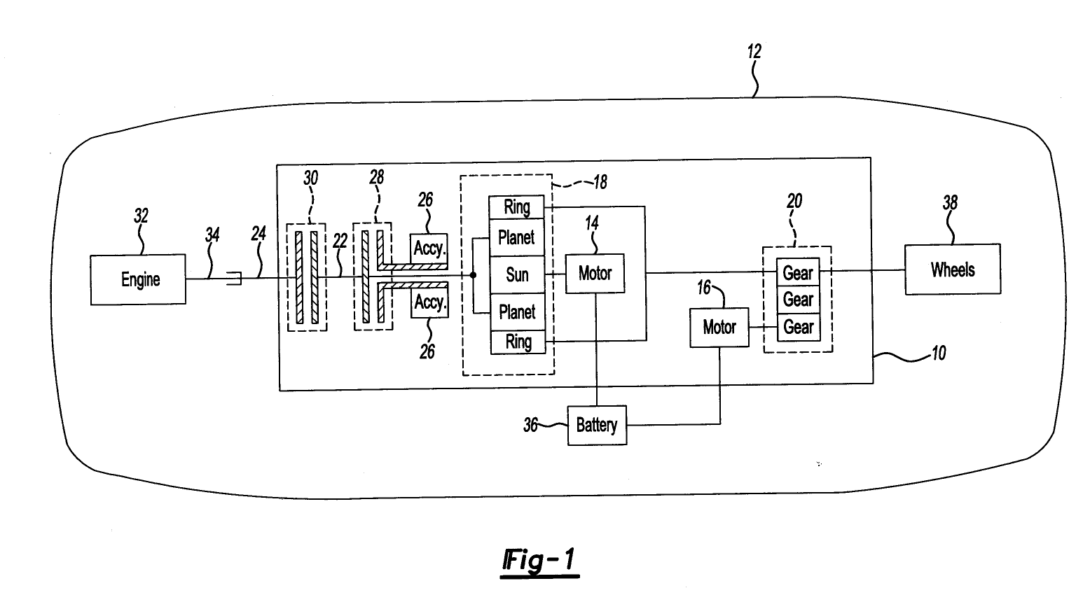

FIG. 1 is a block diagram of transmission system 10 of vehicle 12. System 10 includes motors 14, 16, planetary gear set 18, drive shaft gear set 20, power shaft 22, and input shaft 24. Transmission system 10 also includes accessory unit(s) 26, accessory clutch 28, and engine clutch 30. Input shaft 24 is mechanically coupled with engine 32 via output shaft 34. Motors 14, 16 are electrically coupled with battery 36. Transmission system 10 is mechanically coupled with wheels 38.

Engine 32 may used to drive wheels 38. For example, engine clutch 30 is engaged with power shaft 22, motor 14 immobilizes the sun gear of planetary gear set 18 thus allowing the planet gears of planetary gear set 18 to rotate about the sun gear which, in turn, moves the ring gear of planetary gear set 18 thus driving wheels 38.

Battery 36 may be used to drive wheels 38. For example, engine 32 may be decoupled from power shaft 22 via engine clutch 30, motor 14 may turn the sun gear of planetary gear set 18 which, in turn, drives the planet gears and ring gear of planetary gear set 18 thus driving wheels 38.

Engine 32 and battery 36 may, in combination, be used to drive wheels 38. For example, the planetary gear set 18 may be turned by power from engine 32 and battery 36/motor 14 thus driving wheels 38.

Accessory unit(s) 26, e.g., power steering pump, air conditioner compressor, water pump, oil pump, alternator, etc., is driven by power shaft 22 if accessory clutch 28 is engaged. As described below, power shaft 22 may be selectively engaged with accessory clutch 28 and/or engine clutch 30 such that battery 36/motor 14 and/or engine 32 may provide power to accessory unit(s) 26.

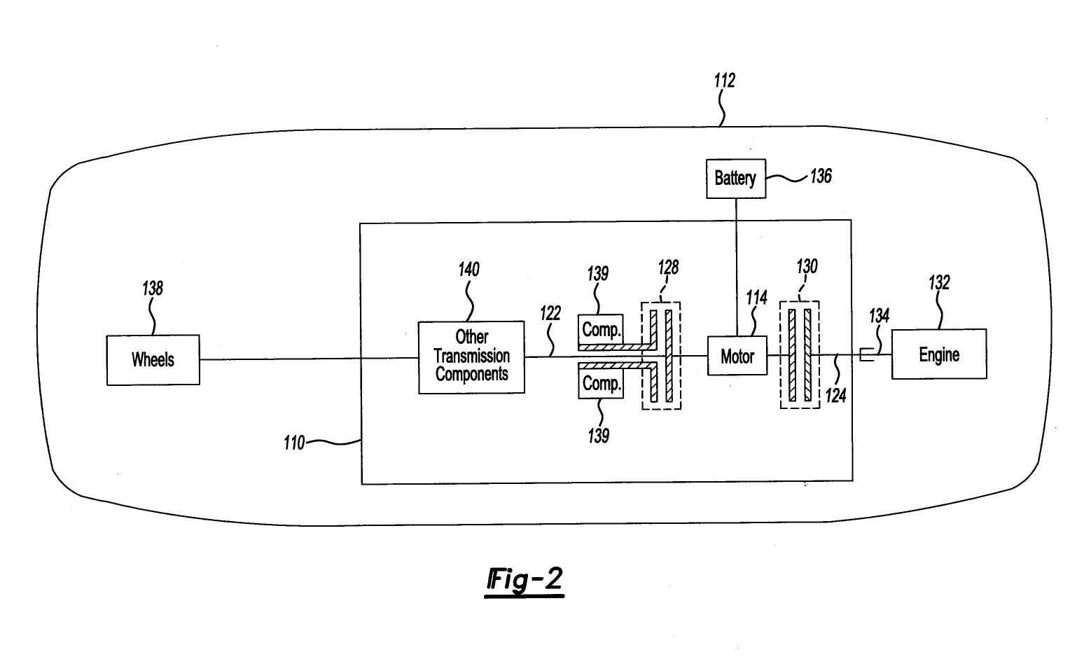

FIG. 2 is a block diagram of an alternative embodiment of transmission system 110 of vehicle 112. Numbered elements differing by factors of 100 have similar descriptions, e.g., engines 32, 132 have similar descriptions. As described above, air conditioning compressor 138 selectively receives power from power shaft 122.

In FIG. 2, accessory clutch 128 is disengaged and engine clutch 130 is disengaged. In this configuration, air conditioning compressor 138 does not receive any rotational power from motor 114 or engine 134 via power shaft 122.

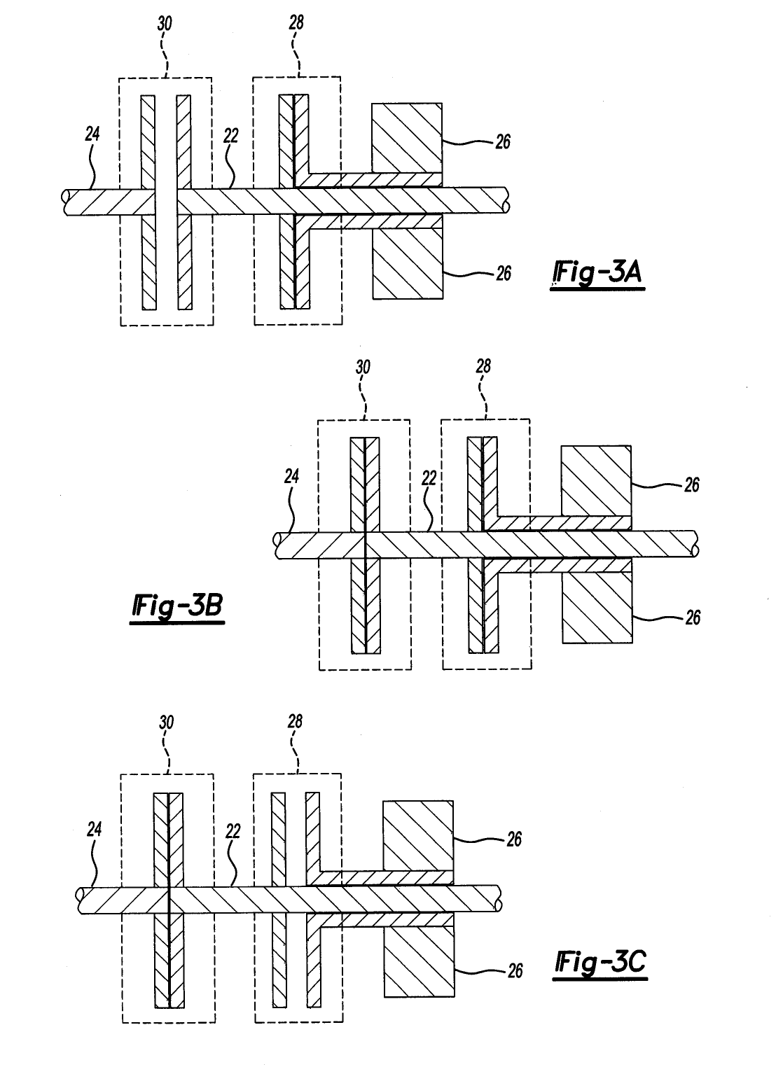

FIG. 3A is a schematic illustration of accessory clutch 28 and engine clutch 30. Accessory clutch 28 is engaged and engine clutch 30 is disengaged. In this configuration, accessory unit 26 may receive power from battery 36 via power shaft 22. For example, the ring gear of planetary gear set 18 is held by drive shaft gear set 20 and motor 14 turns the sun gear of planetary gear set 18 thus turning the planet gears of planetary gear set 18 thus turning power shaft 22.

FIG. 3B is another schematic illustration of accessory clutch 28 and engine clutch 30. Accessory clutch 28 is engaged and engine clutch 30 is engaged. In this configuration, accessory unit 26 may receive power from engine 32 and battery 36 via power shaft 22. For example, motor 14 turns the sun gear of planetary gear set 18 thus turning the planet gears of planetary gear set 18 thus turning power shaft 22. Engine 32 also turns power shaft 22.

FIG. 3C is yet another schematic illustration of accessory clutch 28 and engine clutch 30. Accessory clutch 28 is disengaged and engine clutch 30 is engaged. In this configuration, accessory unit may not receive power via power shaft 22.

Accessory clutch 28 and engine clutch 30 may be actuated using standard techniques. Multiple control strategies consistent with having accessory clutch 28 and engine clutch 30 may also be implemented to deliver power to accessory unit 26 from the desired sources. For example, any time vehicle 12 is on, yet engine 32 is shut down, accessory clutch 28 may be engaged and engine clutch 30 may be disengaged thus powering accessory unit 26 with power from battery 36 via motor 14.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A hybrid vehicle having a wheel comprising:
a first power source to provide power to move the vehicle;
a second power source to provide power to move the vehicle; and
a transmission, including an input shaft, a drive shaft, and a rotationally powered accessory device, for transferring power from at least one of the power sources to the wheel wherein the transmission is mechanically connected with the first power source via the input shaft and operatively connected with the second power source, wherein the drive shaft is configured to be selectively driven by at least one of the first and second power sources, and wherein the accessory device is configured to selectively receive rotational power from the drive shaft.

2. The vehicle of claim 1 wherein the drive shaft is configured to be selectively engaged with the input shaft.

3. The vehicle of claim 2 wherein the transmission further includes a clutch and wherein the drive shaft is configured to be selectively engaged with the input shaft via the clutch.

4. The vehicle of claim 2 wherein the transmission further includes a clutch and wherein the drive shaft is configured to be selectively engaged with the accessory device via the clutch.

5. The vehicle of claim 2 wherein the transmission is electrically connected with the first power source.

6. The vehicle of claim 1 wherein the first power source comprises an engine.

7. The vehicle of claim 1 wherein the second power source comprises a battery.

8. The vehicle of claim 1 wherein the accessory device comprises a power steering pump.

9. The vehicle of claim 1 wherein the accessory device comprises an air conditioner compressor.

10. The vehicle of claim 1 wherein the accessory device comprises a water pump.

11. The vehicle of claim 1 wherein the accessory device comprises an oil pump.

12. The vehicle of claim 1 wherein the accessory device comprises an alternator.

13. A transmission system for a vehicle including a wheel and first and second power sources wherein the transmission transfers power from at least one of the power sources to the wheel, the system comprising:
an input shaft mechanically connected with the first power source;
a drive shaft; and
a rotationally powered accessory device wherein the drive shaft is configured to be selectively driven by at least one of the first and second power sources and wherein the accessory device is configured to selectively receive rotational power from the drive shaft.

14. The system of claim 13 further comprising a clutch and wherein the drive shaft is configured to be selectively engaged with the input shaft via the clutch.

15. The system of claim 13 further comprising a clutch and wherein the drive shaft is configured to be selectively engaged with the accessory device via the clutch.

16. The system of claim 13 wherein the accessory device comprises a power steering pump.

17. The system of claim 13 wherein the accessory device comprises an air conditioner compressor.

18. The system of claim 13 wherein the accessory device comprises a water pump.

19. The system of claim 13 wherein the accessory device comprises an oil pump.

20. The system of claim 13 wherein the accessory device comprises an alternator.
